(19) United States
(12) Patent Application Publication
(10) Pub. No.: US 2010/0241398 A1
(43) Pub. Date: Sep. 23, 2010

(54) Time Interpolation with Time-Varying Waveforms

(75) Inventor: Chin-Hong Cheah, Bukit Mertajam (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 12/406,966

(22) Filed: Mar. 19, 2009

(51) Int. Cl. G04F 13/00; G06F 19/00

(52) U.S. Cl. 702/178; 702/66

(57) ABSTRACT

A method and apparatus for measuring a duration of an event using two time-varying waveforms, each waveform having characteristics such that the waveforms intersect at an intersecting point. The duration of the event can be determined based on the characteristics and a value of the intersecting point of the waveforms. The characteristics of the waveforms can be the gradient or the initial value of the waveforms.

### BACKGROUND OF THE INVENTION

Electronic instrumentation can comprise sophisticated high-resolution time measurement circuits to determine the duration of an event. Some examples of measurement instruments include oscilloscopes and dynamic signal analyzers.

Many techniques exist in the art to measure events with high levels of accuracy. Two such techniques are described in FIG. 1. A timing diagram 101 illustrates an event 103 with the pulse width of Tₑᵥₑₙₜ. A timing diagram 123 of a clock signal is also shown.

In a first time measurement method, a digital counter (not shown) is triggered to count upwards with the rising edge 105 of the event 103. The counter stops counting with the falling edge 107 of the event 103.

Tₑᵥₑₙₜ then can be represented by a length 131 on the timing diagram 123 of the clock signal. The length 131 is determined as a number of counts of the digital counter.

As the counter has a resolution of half a clock cycle 120, this time measurement method can have errors as large as a clock cycle 121. Resolution errors 125,127 occur at the start and end of the event 103.

An attempt to increase the frequency 121 of the clock can lead to a reduction in the magnitude of the resolution errors 125,127. However, limitations on high frequency components to implement a faster clock frequency make this an expensive option.

Time-interpolation can be used to determine, with desired accuracy, the duration of the event 103. In another attempt to overcome the shortfalls of the first time measurement method, a time-amplification method to interpolate the duration of the event 103 has been employed in the art. This method is incorporated in the 54622D 2+16 channel, 100 MHz Mixed-Signal Oscilloscope by Agilent Technologies of Santa Clara, Calif.

In the time-amplification method, the pulse width of the event 103 is linearly stretched by a magnification factor M to allow for a higher resolution measurement. This translates to a significant reduction in the resolution errors 125,127 by the magnification factor M+1.

Included in FIG. 1 are additional charts to illustrate the time-amplification method. A graph 110 and a timing diagram 119 are shown.

A circuit comprising a capacitor (an example of an energy storage device) starts charging at the rising edge 105 of the event 103. The capacitor continues charging for the duration of the rising edge 105 and the event length Tₑᵥₑₙₜ. The voltage across the capacitor can be depicted as a constant gradient up-ramp 105A in the graph 110.

At the falling edge 107 of the event 103, the capacitor begins discharging. The voltage across the capacitor can be depicted as a constant down-ramp 107A. The gradient of the down-ramp 107A is a factor of M less than that the gradient of the up-ramp 105A. A stretched event 115 is derived from the ramps 105A,107A and characterized by the duration Tₑᵥₑₙₜ_{_{—}}_{stretched}. A length 129 of the stretched event 115 is counted by the digital counter.

The pulse width of the event 103 is determined by the following equation:

Tₑᵥₑₙₜ_{_{—}}_{stretched}=(Tₑᵥₑₙₜ×M)+Tₑᵥₑₙₜ equation (1)

Generally, the method can be implemented with a large magnification factor of 20. In addition to the measurement process, calibration of the system is essential for reliable and accurate results.

FIG. 2 is a circuit diagram of the time-amplification method within a measurement system 201. A single ramp-source 213, comprises a capacitor 219 and a current source 217.

A switch 203 opens on the rising edge 105 of the event 103. The up-ramp 105A is generated by charging the capacitor 219 with a current I from the current source 217.

The switch 203 then closes on the falling edge 107. The down-ramp 107A is generated by discharging the capacitor 219 with an equivalent current of I/M when a second current source 209 of charge (I/M+I) is switched in.

With a single energy storage device, the capacitor 219 collects a charge Q directly proportional to the event 103 during the up-ramp 105A. The event 103 is ‘stretched’ by discharging the charge Q at a slower time constant.

A comparator 223 triggers a counter 225 to count the number of clock cycles when the voltage of the ramps 105A and 107A rises above a predetermined voltage reference 117. A clock 229 is coupled to the counter 225. The number of clock cycles counted by the counter 225 represents the length 129 of stretched event 115. The count is utilized by a processor 227 to determine Tₑᵥₑₙₜ using equation (1). The method has resolution errors 125,131.

Although the time-amplification method can provide improved measurement accuracy, limitations to this method still exist. Four disadvantages are listed below.

While the resolution errors 125,131 have been reduced by a factor of M+1, the resolution errors still exist and can be significant for high performance measurements.

New errors, resulting from turning points in the ramps 105A,107A, are introduced into the measurement process. These turning points are the start-point 109, the end-point 113, and an inflection point 111 as the ramp source 213 changes from the up-ramp 105A to the down-ramp 107A. Transients at these turning points 109,111,113 can introduce discontinuity errors.

With a large magnification factor M, constant calibration is required to ensure that the current sources 217 and 209 are matched and thermal drift is minimized. Constant calibration can take precious time away from performing measurements.

With a large magnification factor M, the rate of measurement is also reduced. The rate of measurement is the frequency at which the measurement system can take successive measurements.

Thus, the time-amplification method may not be an appropriate method for high-resolution time measurements, in particular those that are conducted in quick succession.

Accordingly, a need exists for a process and a system to measure events within the cycle of the clock with reasonable accuracy, to calibrate the system expeditiously, and to reset the system in a shorter period.

### BRIEF DESCRIPTION OF THE DRAWINGS

FIG. 1 comprises timing diagrams and charts illustrating two types of measurements of an event in the art;

FIG. 2 is a circuit diagram used in a time-interpolation measurement in the art;

FIG. 3 is a block diagram of a time-interpolation circuit in an embodiment of the invention;

FIG. 4 is a chart and timing diagrams of an embodiment the time-interpolation circuit;

FIG. 5 is a circuit diagram of a time-interpolation circuit in an embodiment of the invention; and

FIG. 6 is a flow chart describing the steps for determining the duration of the event.

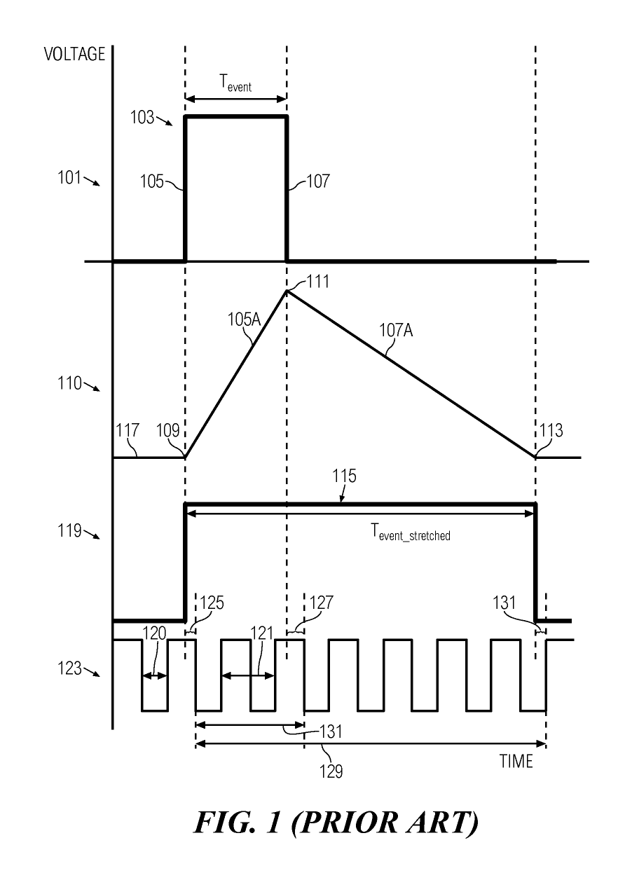

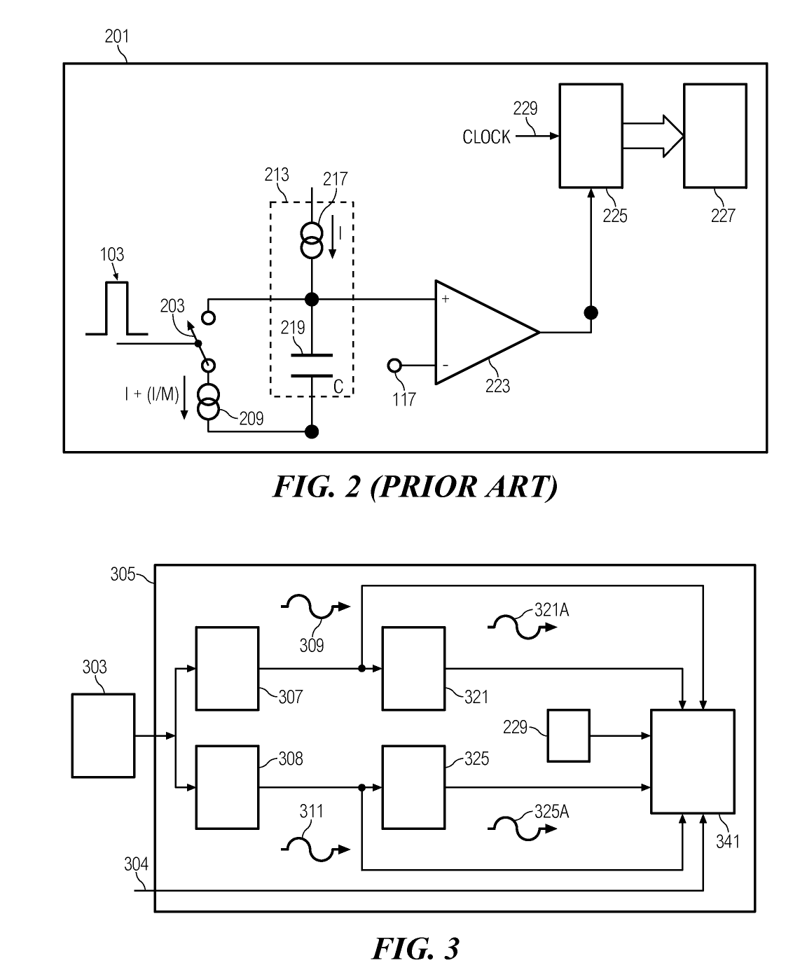

### DETAILED DESCRIPTION

FIG. 3 is a block diagram of a measurement system 305 and a time-interpolation circuit in an embodiment of the invention. A signal input 303 to the measuring system is to be measured.

The input 303 comprises a timing event that can be further separated into two signals. A start-of-signal detector 307 detects the start of the event. The start-of-signal detector 307 outputs an event-start signal 309. An end-of-signal detector 308 detects the end of the event and outputs an event-end signal 311. The event-start signal 309 and event-end signal 311 can be asynchronous to edges of the clock 229 of the measurement system 305.

The detectors 307,308 can comprise an analog comparator (not shown) with one input connected to the signal input 303 and the other input connected to a reference voltage. A switch can be coupled to the output of the comparator. When the output of the comparator changes polarity, a switch can output a voltage to trigger components coupled to the detector. Alternatively, the detectors 307,308 can be part of a processor (identified below) that samples and processes the signal input 303 and outputs the event-start 309 and event-end signals 311.

The respective outputs of the detectors 307,308 are coupled to two waveform sources, a first waveform source 321 and a second waveform source 325.

The first waveform source 321 initiates a first waveform 321A upon receiving the event-start signal 309. The first waveform 321A can be identified by a characteristic set by the waveform source 321.

The second waveform source 325 initiates a second waveform 325A upon receiving the event-end signal 311. The second waveform 325A has a characteristic different to that of the first waveform 321A such that it intersects the first waveform 321A.

The waveforms 321A,325A can be time-varying waveforms. For example, the waveforms 321A,325A can be linear signals with a constant gradient, signals with the characteristics of arcs or ramps, exponential signals, or signals characterized by a non-linear function known in the art.

The characteristics of the first and second waveforms 321A,325A can be the gradients (or slopes) of the respective waveforms 321A,325A. For example, the gradients of the respective waveforms 321A,325A can be a value of the derivative of a non-linear equation identifying the respective waveforms 321A,325A at a specific point. Alternatively, the respective gradients of the waveforms 321A,325A can be identified by the grade of a line defined by two points on the each waveform 321A,325A. Alternatively, the characteristics of the waveforms can be values of the waveforms at an instance in time, for example initial values 427A,429A of the waveforms when the waveform sources 321,325 are triggered.

A processor 341 is coupled to receive the output of the waveform sources 321,325. The processor 341 can sample values of the waveforms 321A,325A at various instances. The processor 341 can have Analog to Digital Converters (ADCs) built within to perform the conversion of the individual waveforms 321A,325A from analog signals to digital signals. The processor 341 can then further analyze the digitized waveform samples. Alternatively, two ADCs can be coupled to receive the outputs of the waveforms 321A,325A directly. The two ADCs can then send the digitized waveform samples to the processor 341.

The processor 341 is coupled to receive an output from the clock 229. The processor can sample the waveforms 321A,325A at predetermined clock cycles. The processor can synchronize the sampling of the waveforms to the clock cycle though a synchronizing module (not shown). The module can be firmware or hardware internal to the processor 341. The module can be initiated by either the event-start signal 309 or the event-end signal 311. Upon being initiated, the synchronizing module outputs a signal that is synchronized with the clock cycle at preprogrammed or predetermined intervals. Examples of hardware synchronizing modules are a series of flip-flops or a multiple threshold timer. Alternatively, the series of flip-flops and the timer can be external to the processor 341.

The processor 341 can determine the gradients of the respective waveforms 321A,325A and an intersecting point based on the sampled values of the waveforms 321A,325A at various times (described in detail below).

Alternatively, the gradients of the waveforms 321A,325A can be known before the measurement commences.

The processor 341 can then determine the duration of the event 421 based on the gradients of the waveforms 321A,325A and the intersecting point (described in detail below). An equation solver or a linear computing device within the processor 341 can determine the duration of the event 421.

A reset input 304 sends a signal to the measurement system 305 to ready the system 305 for the next measurement.

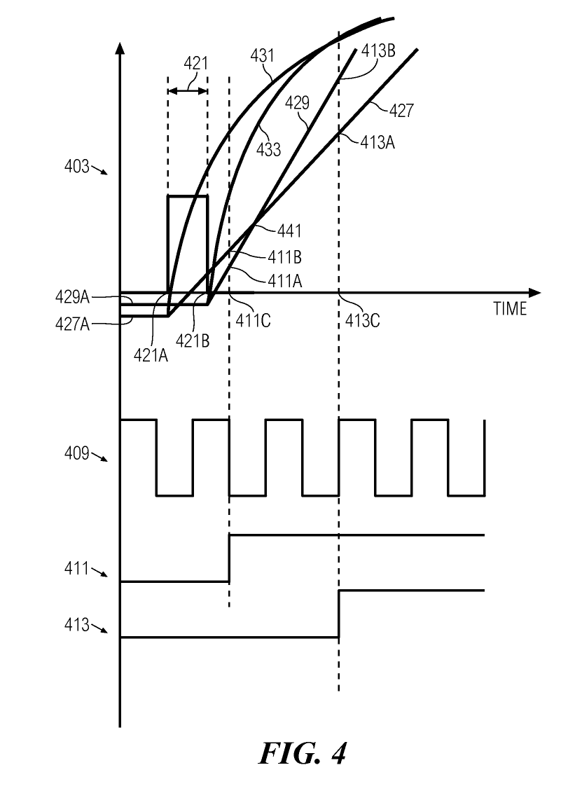

FIG. 4 illustrates a graph 403 of the first and second waveforms 321A,325A, and timing diagrams of the clock 229 and the two trigger outputs synchronized to the clock 229 in the embodiment of FIG. 3.

The input 303 comprises the event 421 to be measured. The event 421 has a start-of-event 421A and an end-of-event 421B identified on the graph 403.

A first plot 427 is representative of the first waveform 321A on the graph 403. The first plot 427 has an initial value 427A and can be characterized by its gradient and the initial value 427A.

Similarly, a second plot 429 representing the second waveform 325A is also drawn on the graph 403. The second plot 429 has an initial value 429A of the second waveform and can be characterized by its gradient and by the initial value 429A.

As described above, the second waveform 325A has a characteristic different to that of the first waveform such that it intersects the first waveform 321A. This can be better understood with the aid of the graph 403 and the corresponding plots 427,429.

In the embodiment, both waveforms 321A,325A are characterized with having positive gradients. The second plot 429 (or the second waveform 325B) has a gradient greater than that of the first plot 427. A larger magnitude gradient, such as that of the second waveform 325A, can be observed by the steeper slope of the plot 429. As a result of the second waveform having a steeper gradient, an intersecting point 441 is shown after the end-of-event 421B.

The polarity of the gradients of the waveforms 321A,325A can be similar or opposite. For example, the polarity of the gradients can differ such that the first waveform 321A has a positive value and the second waveform 325A has a negative value, or vice-versa. In yet another embodiment, the polarity of the gradients of both waveforms can be negative. Similarly, the initial values 427A,429A can also be of similar or different polarity.

If the processor 341 does not sample the value of the intersecting point 441, the value of the intersecting point 441 can be determined by the processor 341 using the characteristics of the waveforms 321A,325A (described in detail below).

The duration of the event 421 can be based on the characteristics of the first and second waveforms 321A,325A and the intersecting point 441.

The processor 341 can compute the duration using an equation of a line for each waveform. The equation of a line is described as:

y=m*x+b equation (2)

where the constant m determines the gradient of a line, and the constant term b determines the point at which the line crosses the y-axis.

The plots 427,429 can be represented by equation (2) in the following manner:

Vᵢₙₜ−Vₛₜₐᵣₜ₁=m1*(Tᵢₙₜ−Tₛₜₐᵣₜ) equation (2-1)

Vᵢₙₜ−Vₛₜₐᵣₜ₂=m2*(Tᵢₙₜ−T_{end}) equation (2-2)

where m1 is the gradient of first waveform 321A and m2 is the gradient of the second waveform 325A, Vₛₜₐᵣₜ₁ is the initial value 427A of the first waveform 321A, Vₛₜₐᵣₜ₂ is the initial value 429A of the second waveform 325A, Vᵢₙₜ is the voltage of the intersecting point 441, Tᵢₙₜ is the time of the intersection point 441, Tₛₜₐᵣₜ is the time of the start-of-event 421A and Tend is the time of the end-of-event 421B.

The event 421 can be determined by simultaneously solving the two equations (2-1) and (2-2). The event 421 can be found using the equation:

$${T}_{event} = \frac{{m}_{1} - {m}_{2}}{{m}_{1} {m}_{2}} \{ {V}_{int} - {V}_{start 1} - [ \frac{{m}_{1}}{{m}_{1} - {m}_{2}} ( {V}_{start 2} - {V}_{start 1} ) ] \} \qquad equation ( 3 )$$

where Tₑᵥₑₙₜ=Tₛₜₐᵣₜ−T_{end}, and Tₑᵥₑₙₜ is the duration of the event 421.

The characteristics of the waveforms 321A,325A and the intersecting point 441 can also be determined from the graph 403 as part of a real-time calibration process (described in detail below).

Timing diagram 409 is representative of the output of the clock 229. Timing diagrams 411,413 are representative of two trigger outputs. The two trigger outputs are outputs of the synchronizing module and are synchronized to separate edges of the clock 229. The two trigger outputs can be internal to the processor 341.

A first trigger occurs at a first instance 411C on the graph 403. Two values corresponding to the first instance 411C, a value 411A of the first waveform 321A and a value 411B of the second waveform 325A can be sampled by the processor 341.

The second trigger occurs at a second instance 413C on the graph 403. Two values corresponding to the second instance 413C, a value 413A of the first waveform 321A and a value 413B of the second waveform 325A, can be sampled by the processor 341.

The gradients of the waveforms 321A,325A can be determined by the processor 341 using the following equations:

$$\begin{matrix}m 1 = \frac{V β 1 - V α 1}{T β - T α} & equation ( 4 ) \\ m 2 = \frac{V β 2 - V α 2}{T β - T α} & equation ( 5 )\end{matrix}$$

where m1 is the gradient of first waveform 321A and m2 is the gradient of the second waveform 325A, Vα1 and Vα2 represent the values 411A,411B of the first and second waveforms at the first instance 411C, Vβ1 and Vβ2 represent values 413A,413B of the first and second waveforms at the second instance 413C, and Tα and Tβ represent the time of the first and second instances 411C, 413C respectively.

The sampled values 411A,411B,413A,413B can also be used to determine the intersecting point 411 of the two waveforms 321A,325A. Substituting the sampled values 411A,411B,413A,413B into the equation of a line in equation (2), the intersecting point 441 can be determined by:

Vᵢₙₜ=(b2*m1−b1*m2)/(m1−m2) equation (6)

where b1=Vα1−m1*Tα, and b2=Vα2−m2*Tα. m1 and m2 are the gradients of the waveforms 321A,325A and can be derived from the equations (4) and (5). Alternatively, b1 and b2 can be found using b1=Vβ1−m1*Tβ and b2=Vβ2−m2*Tβ.

Substituting the variables b1 and b2, the intersecting point 441 can also be expressed as:

Vᵢₙₜ=(m1*Vα2−m2Vα1)/(m1−m2) equation (6-1)

or Vᵢₙₜ=(m1*Vβ2−m2*Vβ1)/(m1−m2) equation (6-2)

In another embodiment, the first and second waveforms 321A,325A can be non-linear exponential signals. Plots 431,433 represent exponential function of the waveforms 321A,325A. The duration of the event 421 can be determined from the characteristics of the waveforms 321A,325A using the plots 431,433.

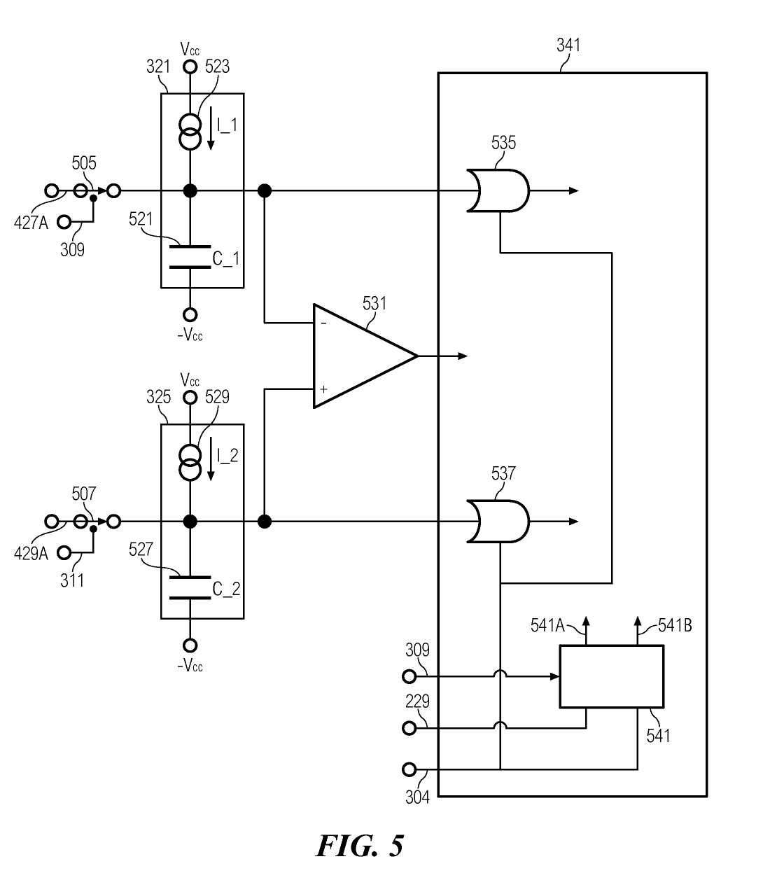

FIG. 5 is a circuit diagram 503 of a time-interpolation circuit in an embodiment of the invention.

A first switch 505 is controlled by the event-start signal 309. The first waveform generator 321 comprises a capacitor 521 and a current source 523. The voltage at the capacitor 521 rises from the initial value 427A when the switch 505 is energized to open. The capacitor 521 is charged at a rate proportional to the output of the current source 523.

Similarly, a second switch 507 is controlled by the event-end signal 311. The second waveform generator 325 comprises a second capacitor 527 and a second current source 529. The voltage at the capacitor 527 rises from the initial value 429A when the switch 507 is energized to open. The capacitor 527 is charged at a rate proportional to the output of the current source 529.

The voltages across each capacitor 521,527 can be depicted as being a ramp with constant gradient. The voltages across each capacitor can be depicted as plots 427,429 and can be representative of the waveforms 321A,325A. Voltages across the capacitors, 521,527 can be sampled by the processor 341 at various instances. The sampled values can be used to determine the gradients of the waveforms, and the intersecting point 411 of the two waveforms.

Two high-speed ADCs 535,537 are shown internal to the processor 341 to sample the values of the voltages across the capacitors 521,527. Alternatively, the processor 341 can have only one ADC to sample the waveforms 321A,325A in turn. In yet another alternative to the embodiment, the ADCs 535,537 can be standalone components, wherein the outputs of the ADCs 535,537 are coupled to the processor 341.

The voltages at the first and second capacitors 521,527 can also be coupled to the input of a detector 531. The detector 531 can alert the processor 341 on the intersecting point 411 of the two waveforms 321A,325A. The output of the detector 531 changes polarity when one input value is greater than the other input value. Using FIG. 4 to illustrate, at the end-of-event 421B the output of the detector 531 is logic level low as the value of first waveform 321A is larger than the second waveform 325A. As the difference in values of the voltages (across the capacitors 521,527) crosses zero, the polarity of the output of the detector 531 will switch from logic low to logic high. The processor 341 can sense a change in polarity and can then sample a value of one or both waveforms 321A,325A. This sampled value can be indicative of the intersecting point 441. With the detector 531 the processor 341 can sample the waveforms 321A,325A when alerted by the detector 531.

The event-end signal 311 can also be coupled to the processor 341. An N-timer 541 is shown within the processor 341. The N-timer 541 is an example of the synchronizing module and can be a dual-threshold timer synchronized to the clock 229. The timer 541 is initiated upon receiving the event-end signal 311. The timer 541 can be preprogrammed to output two signals 541A,541B when the two counters (not shown) within the timer 541 reach two separate thresholds. The outputs signals 541A,541B are synchronized with the clock 229. The thresholds can be determined by the processor 441. The N-timer 541 can have multiple thresholds and outputs in other embodiments. Multiple thresholds and outputs can allow the processor to sample more values of the waveforms to determine their characteristics.

The first output 541A can be generated one clock cycle after the end-of-event 421B. The timing diagram 411 represents the first output 541A of the N-timer 541.

The second output 541B can be generated a (fixed) number of clock cycles after end-of-event 421B. The timing diagram 413 represents the second output 541B of the N-timer 541.

Alternatively, the timer can be initiated by the event-start signal 309. In this embodiment, the first trigger 541A can be sent more than a clock cycle after the start-of-event 421A. This is to allow the end-of-event 421B to occur and to measure values of the second waveform 325A above the initial value 429A. Subsequently, the second trigger 541B can be sent at a predetermined number of clock cycles after the first threshold.

The reset input 304 sends a signal to the processor 341. The reset signal 304 resets the timer 541 by setting its internal mechanism to zero. The reset signal 304 can also reset the ADCs 535,537.

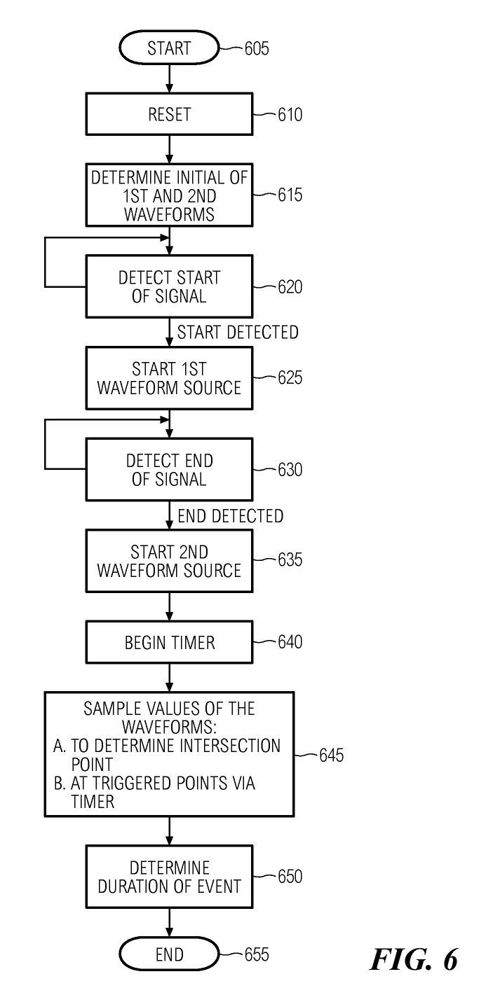

FIG. 6 is a flow chart describing the steps for determining the duration of the event 421.

STEP 605 describes the start of the flow chart.

At STEP 610, the measurement system is readied for an input signal to be measured by receiving a reset input to the measurement system 305. For example, a reset input 304 is received by the measurement system 305. The processor 341 resets the switches 505,507 and resets the ADCs 535,537. The N-timer 541 can reset its internal counters to zero.

At STEP 615, the initial values of the first and second waveforms are determined. For example, the processor 341 samples the initial values 427A,429A of the first and second waveforms 321A,325A.

Alternatively, the processor 341 can continuously sample the voltages across the capacitors 521,527 up to and until the event-start signal 309 to determine separate averages of the initial values 427A,429A of the waveforms.

In yet another embodiment of the invention, the initial values 427A,429A of the waveforms 321A,325A can be known before the measurement commences, for example having a value of zero. In this embodiment, the STEP 615 can be passed over.

At STEP 620, the start of the event is determined by the measurement system 305. For example, the start-of-event 421A can be identified by the start-of-signal detector 307. The detector 307 can output the event-start signal 309.

Alternatively, the processor 341 can determine the start-of-event 421A. In this embodiment, the signal input 303 is sent to the processor 341. The processor can identify the start-of-event 421A by constantly sampling the signal input 303. The processor can then output the event-start signal 309.

At STEP 625, the first waveform is initiated at the start of the event. For example, the first waveform 321A is activated when the event-start signal 309 triggers the first waveform source 321. In another example, the event-start signal 309 energizes the first switch 505. This allows the current source 523 to charge the capacitor 521.

Alternatively, the processor 341 can output a signal to initiate the first waveform source 321 after detecting the start of the signal 303.

The first waveform 321A can have a characteristic defined by its gradient. The gradient can be known before the measurement begins. In the embodiment of FIG. 5, the gradient m1 of the waveform can be derived by the equation:

m1=I_{—}1/C_{—}1 equation (7)

where I_1 is the value of the current source 523, and C_1 is the capacitance of the capacitor 521.

Alternatively, the gradient can be determined by performing calibration while the measurement is being performed (described in detail below). This is also referred to as real-time waveform calibration.

At STEP 630, the end of the event is determined by the measurement system 305. For example, the end-of-event is determined by the detector 308. The detector 308 can output the event-end signal 311.

Similarly, in the alternative described above, the processor 341 can determine the end of the event and output the event-end signal 311.

At STEP 635, the second waveform is initiated at the end of the event. For example, the second waveform source 325 outputs the waveform 325A upon receiving the event-end signal 311.

In another example, the event-end signal 311 energizes the second switch 507. This allows the current source 529 to charge the capacitor 527.

The second waveform can have a characteristic defined by its gradient that can be known before the measurement begins. The gradient m2 of the waveform can be derived by the equation:

m2=I_{—}2/C_{—}2 equation (8)

where I_2 is the value of the current source 529, and C_2 is the capacitance of the capacitor 527.

In another embodiment wherein a voltage source and inductors are employed as the waveform sources 321,325, the gradients of the waveforms 321A,325A can be determined by values of the voltage source and the inductor of each waveform source.

The gradient m2 is different to the gradient m1 such that the second waveform intersects the first waveform. For example, the characteristic of the second waveform is a gradient m2 that is larger than m1 such that it intersects after the end-of-event 421B. Alternatively, the gradient m2 can be smaller than m1 such that the intersecting point 411 occurs before the end-of-event 421B when drawn on the graph 403. In another embodiment, the polarity of the gradients of the waveforms can be similar or can be different.

Mentioned above, the gradient can be determined by a calibration routine while the measurement is being performed. STEPS 640-645 can describe a real-time waveform calibration process.

At STEP 640, a timer is initiated. For example, the event-end signal 311 can initiate the timer 541. The two outputs 541A,541B of the timer can trigger the processor 341 to sample the values of waveforms 321A,325A. The timer output 541A,541B can be synchronized to the clock 229. The timer 541 can output signals 411,413 when its internal counter reaches predetermined thresholds.

Alternatively, the event-start signal 309 can initiate the count by being coupled to the timer 541. This can be done at STEP 620.

At STEP 645, the waveforms are sampled by the processor 341. The sampled values allow the processor to determine the intersecting point 411 and the characteristics of the waveforms. For example, the processor 341 can sample values of the first and second waveforms 321A,325A continuously and compare the sampled values. An intersecting value can be determined when the values of the two waveforms 321A,325A are equal to each other. Alternatively, a percentage range can be set to determine when the values of the two waveforms 321A,325A are substantially equal to each other.

Alternatively, the values of the waveforms 321A,325A can be sampled by the processor 341 upon receiving the output of the detector 531. As described above, the detector receives the output of the two waveform sources 321,325 and provides a trigger when the first and second waveforms 321A,325A are of substantially equal value.

The waveforms 321A,325A can be sampled at the two (or more) instances 411C, 413C. The sampled values 411A,411B,413A,413B at the two instances 411C, 413C can be used to determine the gradients of the waveforms 321A,325A using the equations (4) and (5).

The sampled values 411A,411B,413A,413B can also be used to determine the intersecting point 411 of the two waveforms 321A,325A. The processor can determine the gradients of the waveforms using equations (4) and (5), and the value of the intersecting point 441 using equation (6).

At STEP 650, the duration of the event is determined. With the characteristics of the waveforms 321A,325A, for example the gradients and the initial values 427A,429A of the waveforms 321A,325A, and the intersecting point 441, the processor 341 can determine the duration of the event 421 using equation (3) above.

At STEP 655, the method for determining the duration of the event 421 ends.

While the embodiments described above constitute exemplary embodiments of the invention, it should be recognized that the invention can be varied in numerous ways without departing from the scope thereof. It should be understood that the invention is only defined by the following claims.

1. A method for measuring a duration of an event, the method comprising:
starting a first time-varying waveform at a start of the event, the first time-varying waveform having a first characteristic;
starting a second time-varying waveform at an end of the event, the second time-varying waveform having a second characteristic such that the second time-varying waveform intersects the first time-varying waveform; and
determining the duration of the event based on the first and second characteristics and a value of an intersecting point of the first and second time-varying waveform.

2. The method of claim 1 wherein the time-varying waveforms are substantially linear.

3. The method of claim 1 wherein the first and second characteristics are gradients.

4. The method of claim 3, wherein the gradients are known prior to the step of starting the first time-varying waveform.

5. The method of claim 4, further comprising the steps of:
sampling at least one value of each time-varying waveform; and
wherein the intersecting point is determined using the at least one value.

6. The method of claim 1, further comprising the steps of:
sampling at least two values of each time-varying waveform at different times; and
determining the gradient of each time-varying waveform using the at least two values.

7. The method of claim 1, further comprising the step of sampling the value of the intersecting point.

8. The method of claim 1, further comprising the step of sampling an initial value of the first time-varying waveform at the start of the event, and wherein the step of determining the duration further comprises determining the duration based on the initial value.

9. The method of claim 1, further comprising the step of sampling an initial value of the second time-varying waveform at the end of the event and wherein the step of determining the duration further comprises determining the duration based on the initial value.

10. The method of claim 1, wherein the duration of the event is based on the characteristics of the first and second time-varying waveforms and the intersecting point using an equation of a line.

11. An apparatus for measuring a duration of an event, the apparatus comprising:
a first time-varying waveform having a first characteristic, the first time-varying waveform being initiated at a start of the event, and
a second time-varying waveform initiated at an end of the event, the second time-varying waveform having a second characteristic such that the second time-varying waveform intersects the first time-varying waveform at an intersection point; and
a processor coupled to receive the first and second time-varying waveforms, and determine the duration of the event based on characteristics of the first and second time-varying waveforms and the intersection point.

12. The apparatus of claim 11, wherein the first and second time-varying waveforms are generated from at least one waveform source.

13. The apparatus of claim 11, wherein the first and second time-varying waveforms are substantially linear, and the characteristics of the first and second time-varying waveforms are gradients.

14. The apparatus of claim 11, further comprising a timer, and wherein the processor samples values of the first and second time-varying waveforms at various times, such that the characteristics of the first and second time-varying waveforms can be determined using the values at the various times.

15. An apparatus for measuring a duration of an event, the apparatus comprising:
a first waveform source starting a first time-varying waveform with a first gradient at a start of the event;
a second waveform source starting a second time-varying waveform at an end of the event, the second time-varying waveform having a second gradient such that the second time-varying waveform intersects the first time-varying waveform at an intersection point;
a detector coupled to receive the first and second time-varying waveforms, and coupled to provide a trigger when the first and second time-varying waveforms are of substantially equal value; and
a processor coupled to receive the first and second time-varying waveforms and the trigger, the processor to sample an intersecting value of the first and second time-varying waveforms upon receiving the trigger, and the processor to determine the duration of the event based on the gradients of the first and second time-varying waveforms and the intersecting value.

16. The apparatus of claim 15, wherein the first and second time-varying waveforms are substantially linear, and the first and second gradients are known.

17. The apparatus of claim 15, wherein the processor samples an initial value of one of the first and second time-varying waveforms, and wherein the processor determines the duration based on the initial value.

18. The apparatus of claim 15, further comprising:
a first initial voltage coupled to the first waveform source;
a second initial voltage coupled to the second waveform source, such that the first and the second time-varying waveforms start at the respective first and second initial voltage; and
wherein the processor determines the duration based on the first and second initial voltages.

19. The apparatus of claim 15, wherein the processor determines duration of the event is based on an equation of a line.

20. The apparatus of claim 15, wherein the first and second waveform sources are ramp-sources.
